(19) United States
(12) Patent Application Publication
(10) Pub. No.: US 2025/0289311 A1
(43) Pub. Date: Sep. 18, 2025

(54) Vehicle Electric Power System and Refrigerator Vehicle Including Vehicle Electric Power System

(71) Applicants: Hyundai Motor Company, Seoul (KR); Kia Corporation, Seoul (KR)

(72) Inventor: Se Hoon Park, Hwaseong-Si (KR)

(21) Appl. No.: 18/799,134

(22) Filed: Aug. 9, 2024

(30) Foreign Application Priority Data
Mar. 15, 2024 (KR) 10-2024-0036624

(51) Int. Cl. B60L 1/00; B60L 58/12

(52) U.S. Cl. CPC B60L 1/00; B60L 58/12

(57) ABSTRACT

A power system may comprise a motor system configured to use an electric power, of a vehicle, configured for travelling, wherein the motor system is configured to control, based on the electric power, a movement of the vehicle, a first electric power load configured to use a first electric power, of the vehicle, configured for non-travelling, a second electric power load configured to use a second electric power, of the vehicle, configured for non-travelling, wherein the second electric power is lower than the first electric power, a battery configured to provide the electric power configured for travelling and the first electric power configured for non-travelling, and a controller configured to adjust, based on a state of charge (SOC) value of the battery, an output value of the first electric power load.

### CROSS-REFERENCE TO RELATED APPLICATION(S)

This application claims benefit of priority to Korean Patent Application No. 10-2024-0036624 filed on Mar. 15, 2024 in the Korean Intellectual Property Office, the disclosure of which is incorporated herein by reference in its entirety.

### TECHNICAL FIELD

The present disclosure relates to a vehicle electric power system and a refrigerator vehicle including the same.

### BACKGROUND

Eco-friendly vehicles refer to low-carbon, high-fuel-efficiency vehicles emitting fewer air pollutants and greenhouse gases, and having excellent fuel efficiency, such as the use of new electric power sources such as batteries or fuel cells and ultra-high-efficient new combustion techniques. Such eco-friendly vehicles may be largely divided into electric power-based vehicles and engine-based vehicles. In particular, electric power-based vehicles are referred to as xEVs. xEVs may include hybrid electric vehicles (HEV), plug-in hybrid electric vehicles (PHEV), electric vehicles (EV), and fuel cell electric vehicles (FCEV).

An electric power-based vehicle may include a battery providing travelling electric power, and a travel distance of the electric power-based vehicle may be determined by an energy capacity of the battery. As the energy capacity of the battery decreases, a frequency of charging used for electric power-based vehicles may increase. As a frequency of charging performed by a driver decreases, the driver may be more likely to miss charging. If the driver misses charging, a state of charge of the battery may be significantly lowered, and accordingly the electric power-based vehicle may suddenly stop, incurring additional costs (for example, towing costs) or time used to travel to a charging station for charging the battery. Accordingly, energy efficiency and/or operational stability of electric power-based vehicles may be practical.

### SUMMARY

According to the present disclosure, a power system may comprise a motor system configured to use an electric power, of a vehicle, configured for travelling, wherein the motor system is configured to control, based on the electric power, a movement of the vehicle, a first electric power load configured to use a first electric power, of the vehicle, configured for non-travelling, a second electric power load configured to use a second electric power, of the vehicle, configured for non-travelling, wherein the second electric power is lower than the first electric power, a battery configured to provide the electric power configured for travelling and the first electric power configured for non-travelling, and a controller configured to adjust, based on a state of charge (SOC) value of the battery, an output value of the first electric power load.

The power system, wherein the controller is configured to adjust, based on the SOC value of the battery, an output value of the first electric power within a larger range compared to an adjustable range of the electric power.

The power system, wherein the controller is configured to decrease, based on whether an available output value of the first electric power load being lower than a reference load output value and the SOC value being lower than a reference low SOC value, an output value of the first electric power load.

The power system, wherein the controller is configured to, based on the battery being charged after the output value of the first electric power load being decreased, restore an output value of the first electric power load.

The power system, wherein the controller is configured to increase, based on reception of a load output lowering limit command signal, at least one of the reference low SOC value and the reference load output value.

The power system, wherein the controller is configured to increase, based on reception of a load output lowering limit command signal, a lower output value limit of the first electric power load.

The power system, wherein the second electric power load comprises a navigation device disposed on the vehicle, and the controller is configured to control, based on the SOC value of the battery being lower than a reference low SOC value, the navigation device to generate charging station guidance information.

The power system, wherein the controller is configured to determine an output value of the first electric power load based on at least one of information, generated by the navigation device, about a remaining distance to a charging station, or information, generated by the navigation device, about terrain to the charging station.

The power system, wherein the controller is configured to increase, based on the SOC value of the battery being higher than a reference high SOC value, an output value of the first electric power load.

The power system, wherein the controller is configured to turn on, based on the SOC value of the battery being higher than the reference high SOC value and the first electric power load being turned off, the first electric power load.

The power system, wherein the motor system is configured to generate, based on regenerative braking, energy, the battery is configured to store the energy, and the controller is configured to control, based on the SOC value of the battery being higher than the reference high SOC value, the energy to bypass the battery and provide the energy to the first electric power load.

The power system, wherein the first electric power load comprises a refrigerator.

According to the present disclosure, a power system may comprise a motor system configured to use an electric power, of a vehicle, configured for travelling, and to generate, based on regenerative braking, energy, wherein the motor system is configured to control, based on the electric power, a movement of the vehicle, a first electric power load configured to use a first electric power, of the vehicle, configured for non-travelling, a second electric power load configured to use a second electric power, of the vehicle, configured for non-travelling, wherein the second electric power is lower than the first electric power, a battery configured to provide the electric power configured for travelling and the first electric power configured for non-travelling, and to store the energy generated based on the regenerative braking, and a controller configured to provide, based on a state of charge (SOC) value of the battery being higher than a reference high SOC value, the energy to the first electric power load.

The power system, wherein the first electric power load is configured to receive, based on the SOC value of the battery being higher than the reference high SOC value and from the motor system, the energy generated based on the regenerative braking.

The power system, wherein the motor system is configured to use the regenerative braking in a braking situation of the vehicle.

The power system, wherein the second electric power load comprises a navigation device disposed on the vehicle, and the controller is configured to control, based on the SOC value of the battery being lower than a reference low SOC value, the navigation device to generate charging station guidance information.

The power system, wherein the first electric power load comprises a refrigerator.

According to the present disclosure, a power system may comprise a motor system configured to use an electric power, of a vehicle, configured for travelling, wherein the motor system is configured to control, based on the electric power, a movement of the vehicle, a first electric power load configured to use a first electric power, of the vehicle, configured for non-travelling, a second electric power load configured to use a second electric power of the vehicle, wherein the second electric power is lower than the first electric power, wherein the second electric power load comprises a navigation device disposed on the vehicle, a battery configured to provide the electric power configured for travelling and the first electric power configured for non-travelling, and a controller configured to control, based on a state of charge (SOC) value of the battery being lower than a reference low SOC value, the navigation device to generate charging station guidance information.

The power system, wherein the controller is configured to decrease an output value of the first electric power load, and determine an output value of the first electric power load based on at least one of information, generated by the navigation device, about a remaining distance to a charging station, or information, generated by the navigation device, about terrain to the charging station.

The power system, wherein the first electric power load comprises a refrigerator.

### BRIEF DESCRIPTION OF DRAWINGS

The above and other examples, features, and advantages of the present disclosure will be more clearly understood from the following detailed description, taken in conjunction with the accompanying drawings, in which:

FIG. 1 and FIG. 2 show examples of a vehicle electric power system according to an example of the present disclosure; and

FIG. 3, FIG. 4, FIG. 5, and FIG. 6 show examples of flowcharts showing sequential operations of a vehicle electric power system according to an example of the present disclosure.

### DETAILED DESCRIPTION

Various modifications may be made to the examples. Here, the examples should not be construed as being limited to the present disclosure and should be understood to include all changes, equivalents, and replacements within the idea and the technical scope of the disclosure.

The terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component. The term “and/or” may include combinations of a plurality of related described items or any of a plurality of related described items.

The terminology used herein is for the purpose of describing particular examples only and is not to be limiting of the examples. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” if used in this disclosure, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein, including technical or scientific terms, have the same meanings as those generally understood by one of ordinary skill in the art. Terms defined in dictionaries generally used should be construed to have meanings matching contextual meanings in the related art and are not to be construed as having an ideal or excessively formal meaning, unless otherwise defined herein.

As used herein, a vehicle (including an electric vehicle) refers to various vehicles transporting a transported object such as a person, an animal, or an object from a starting point to a destination. Such vehicles are not limited to vehicles travelling on roads or tracks.

Hereinafter, preferred examples of the present disclosure will be described in more detail with reference to the attached drawings.

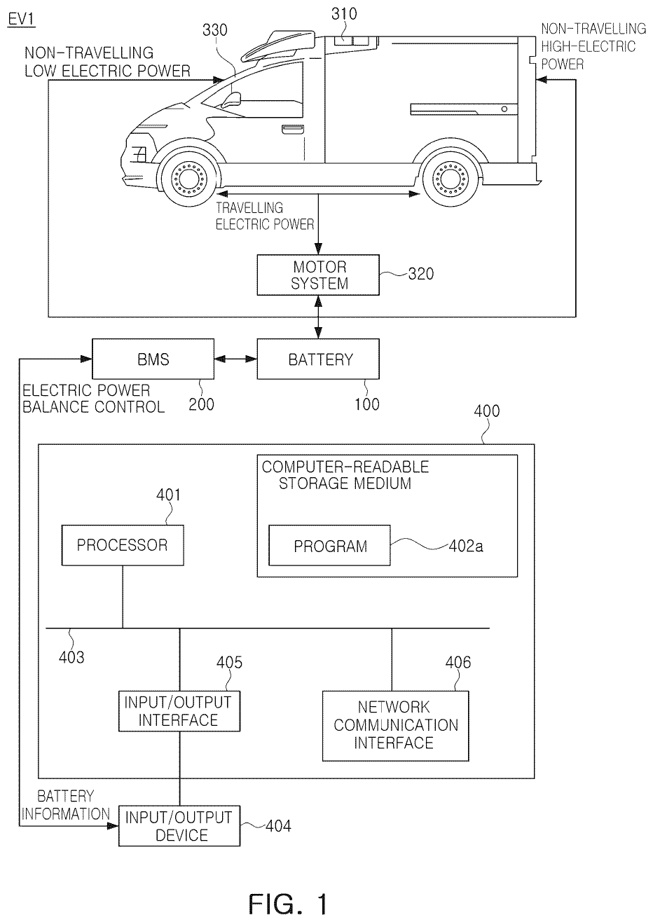

Referring to FIG. 1, a vehicle electric power system according to an example of the present disclosure may include a motor system 320, a non-travelling high-electric power load 310, a non-travelling low-electric power load 330, a battery 100, and a controller 400, and may be included in a vehicle EV1.

The motor system 320 may be configured to use travelling electric power of the vehicle EV1. The vehicle EV1 may be implemented as one of a hybrid electric vehicle (HEV), a plug-in hybrid electric vehicle (PHEV)), an electric vehicle, and a fuel cell electric vehicle (FCEV), but the present disclosure is not limited thereto.

For example, the motor system 320 may include a motor, an inverter, and a control integrated circuit. The inverter may receive direct current (DC)-based travelling electric power of from the battery 100, and the control integrated circuit may control a plurality of switches included in the inverter, such that the inverter may convert the DC into alternating current (AC). The motor may convert the converted AC-based travelling electric power into torque. The vehicle EV1 may travel by applying the torque to wheels. For example, a motor may be implemented as an induction motor, a permanent magnet synchronous motor, or the like.

Depending on a design thereof, the motor system 320 may generate energy by performing regenerative braking on rotating wheels, and may supply the generated energy to a battery 110. As the regenerative braking is more frequently used, the vehicle EV1 may have higher energy efficiency.

The non-travelling high-electric power load 310 may be configured to use non-travelling high-electric power of the vehicle EV1. The non-travelling high-electric power may refer to electric power that is not substantially used for travelling of the vehicle EV1 and is relatively large in amount as compared to non-travelling low electric power. Here, a large amount of electric power may mean that a maximum amount of electric power (for example, Watt-hour), usable by a load using electric power during unit time (for example, 1 hour or 1 day), is relatively large. For example, the non-travelling high-electric power load 310 may include, but is not limited to, a refrigerator.

The non-travelling low-electric power load 330 may be disposed on vehicle EV1, and may be configured to use an amount of electric power lower than that of the non-travelling high-electric power load 310. The non-travelling low electric power may refer to electric power that is not substantially used for travelling of the vehicle EV1 and is relatively small in amount as compared to non-travelling high-electric power. For example, the non-travelling low-electric power load 330 may include electronic devices (for example, an air conditioner, a heater, a lighting device, a navigation device, audio system, electric windows/mirrors, wireless charging pads, head-up display, etc.), forming a driving environment of a driver of vehicle EV1, and may include control devices (for example, an electronic control unit, a transmission control unit, a transmission management system electronic control unit (TMS ECU), and an anti-locking brake system electronic control unit (ABS ECU)), performing non-travelling control.

The battery 100 may be configured to provide travelling electric power, used by the motor system 320, and non-travelling high-electric power, used by the non-travelling high-electric power load 310. For example, the battery 100 may include a high-voltage battery (e.g., lithium-ion batteries, nickel-metal hybrid batteries), and the high-voltage battery may be used to generate a large amount of travelling electric power and non-travelling high-electric power. Depending on a design thereof, the battery 100 may include both a high-voltage battery and a low-voltage battery (e.g., lead-acid batteries, lithium-ion 12-volt batteries, auxiliary batteries in hybrid/electric vehicles), and the low-voltage battery may be configured to provide non-travelling low electric power, used by the non-travelling low-electric power load 330.

When compared to a general electric vehicle, a vehicle EV1 including the non-travelling high-electric power load 310 may use a larger total amount of electric power, and thus may use a larger energy capacity of the battery 100. The energy capacity of the battery 100 may increase as a size of the battery 100 increases. However, the size of the battery 100 may be limited by other design conditions (including cost) of the vehicle EV1.

As the energy capacity of the battery 100 decreases, the driver of the vehicle EV1 may need to increase a frequency of charging of the battery 100. While the battery 100 is being charged, it may be difficult for the vehicle EV1 to travel. The vehicle EV1 including the non-travelling high-electric power load 310 may be implemented as an industrial transportation means, it may be difficult for the driver of the vehicle EV1 to increase a frequency of charging the battery 100 or to secure time used to charge the battery 100. If it is difficult for the driver of the vehicle EV1 to increase a frequency of charging of the battery 100 or to secure time used to charge the battery 100, a risk of travelling of the vehicle EV1 or an operation of the non-travelling high-electric power load 310 suddenly stopping may be increased due to a decrease in state of charge (SOC) of the battery 100.

The controller 400 may be configured to control, in response to an SOC of the battery 100, lowering or raising of the non-travelling high-electric power used by the non-travelling high-electric power load 310. Accordingly, the vehicle electric power system according to an example of the present disclosure may improve energy efficiency and/or operational stability of the vehicle EV1 using both travelling electric power and non-travelling high-electric power, thereby preventing a risk of travelling of the vehicle EV1 or an operation of the non-travelling high-electric power load 310 suddenly stopping.

For example, the battery 100 or the controller 400 may include a battery management system (BMS) 200, and the battery management system 200 may be implemented as a computing device (a processor, a computer-readable storage medium, a communication bus, an input/output device, an input/output interface, and a network communication interface). The battery management system 200 may sense values of voltage, current, and temperature of the battery 100 and may generate, based on the sensed values, SOC information of the battery 100. The battery management system 200 may transmit the SOC information to the controller 400 or the input/output device 404.

The controller 400 may determine, in response to the SOC information received from the battery management system 200, whether the SOC of the battery 100 is a low SOC or a high SOC. The controller 400 may control, in response to the SOC of the battery 100, lowering or raising of non-travelling high-electric power in a larger range, as compared to lowering or raising of travelling electric power.

For example, if the SOC of the battery 100 is a low SOC, the controller 400 may control the non-travelling high-electric power to be lowered more preferentially than the travelling electric power. A distance between the vehicle EV1 and the charging station may be fixed, such that lowering of the travelling electric power may have no significant effect in reducing a risk of the vehicle EV1 stopping before reaching the charging station. Conversely, a result of lowering the non-travelling high-electric power (for example, a decrease in freshness of items in a refrigerator according to an increase in internal temperature of the refrigerator for a long period of time) may not appear, at least for a short period of time, and lowering of the non-travelling high-electric power may reduce a risk of an operation of the non-travelling high-electric power load 310 suddenly stopping. Accordingly, if the non-travelling high-electric power is lowered more preferentially than the travelling electric power, a risk of travelling of the vehicle EV1 or an operation of the non-travelling high-electric power load 310 suddenly stopping due to a decrease in the SOC of the battery 100 may be effectively reduced.

For example, the controller 400 may transmit, to the battery management system 200, a command signal (or electric power balance control signal) lowering the non-travelling high-electric power. The battery management system 200 may perform control (for example, on/off control and/or resistance control) on a relay and/or resistor electrically connected between the battery 100 and the non-travelling high-electric power load 310. Accordingly, current flowing from the battery 100 to the non-travelling high-electric power load 310 may decrease, and the non-travelling high-electric power may be lowered. In this case, the travelling electric power may be substantially maintained, such that the battery management system 200 may control electric power balance to reduce a proportion of the non-travelling high-electric power in total electric power provided by the battery 100.

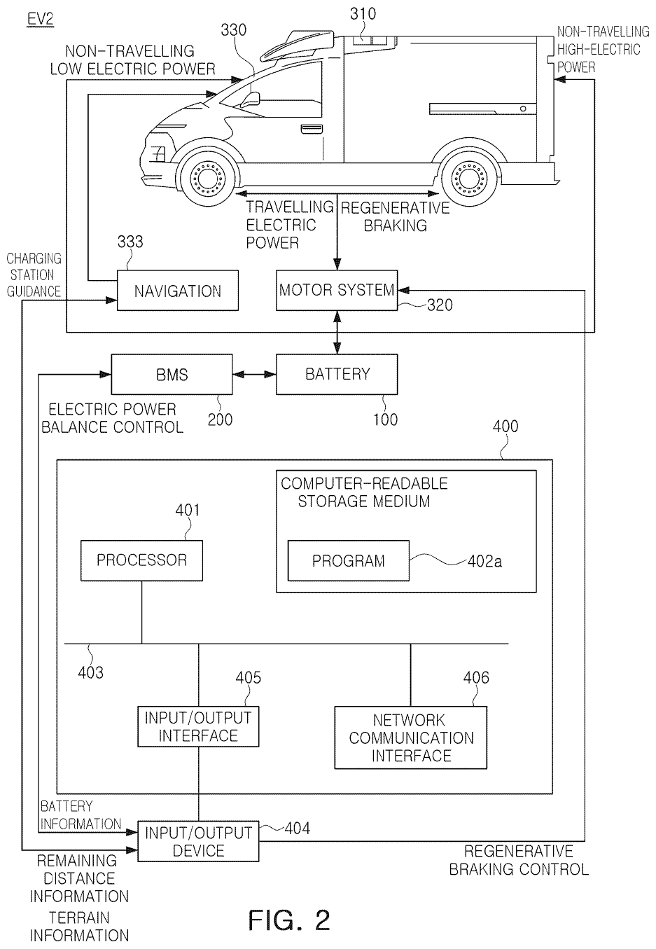

Referring to FIG. 2, the controller 400 of the vehicle electric power system according to an example of the present disclosure may be included in a vehicle EV2, and may control energy generated by the motor system 320 using regenerative braking to be provided to the non-travelling high-electric power load 310 if an SOC of the battery 100 is higher than a reference high SOC.

If the SOC of the battery 100 is a high SOC, it may be difficult for the battery 100 to store energy generated using regenerative braking in the motor system 320. In this case, if non-travelling high-electric power is raised, the non-travelling high-electric power load 310 (e.g., refrigerators/coolers, induction cooktops, microwave ovens, electric water heaters, high-power charging ports, external power outlets such as power inverters converting the vehicle's DC power to AC power for running household appliances or power tools, etc.) may a larger amount of non-travelling high-electric power at least for a short period of time in the same manner as using, in advance, a portion of electric power to be used in the future (for example, further lowering, in advance, an internal temperature of a refrigerator than a reference temperature). Alternatively or additionally, a state of the non-travelling high-electric power load 310 may be switched from an OFF state or sleep mode to an ON state, such that the non-travelling high-electric power may be raised. The sleep mode may be an intermediate state between the OFF state and the ON state.

Accordingly, the vehicle EV2 may have higher energy efficiency, such that a lower frequency of charging of the battery 100 may also be used, thereby reducing a risk of travelling of the vehicle EV2 or an operation of the non-travelling high-electric power load 310 of the vehicle EV2 suddenly stopping due to a driver of the vehicle EV2 having difficulty in increasing a frequency of charging of the battery 100 or securing time used to charge the battery 100.

If the SOC of the battery 100 is higher than a reference high SOC, the non-travelling high-electric power load 310 may receive, from the motor system 320, the energy generated using the regenerative braking not through the battery 100. Accordingly, transmission energy loss of the energy generated using the regenerative braking may be reduced, such that the vehicle EV2 may have higher energy efficiency.

For example, the controller 400 may determine, in response to SOC information of the battery 100 received from the battery management system 200, whether the SOC of the battery 100 is a high SOC, may transmit, to the motor system 320, a command signal to maintain the regenerative braking if the SOC of the battery 100 is the high SOC, and may transmit, to the battery management system 200, a command signal to block an electrical connection path between the battery 100 and the motor system 320 (for example, to block a relay). Accordingly, the motor system 320 may bypass the battery 100 and provide, to the non-travelling high-electric power load 310, the energy generated using the regenerative braking.

The motor system 320 may use the regenerative braking even if the SOC of the battery 100 is the high SOC, and thus may use the regenerative braking in each braking situation of the vehicle EV2 regardless of the SOC of the battery 100. Accordingly, the vehicle EV2 may not have a braking structure other than the regenerative braking of the motor system 320, and costs used for manufacturing the vehicle EV2 may be reduced.

Referring to FIG. 2, a non-travelling low-electric power load 330 of the vehicle electric power system according to an example of the present disclosure may include a navigation device 333, and the controller 400 may control the navigation device 333 to generate charging station guidance information if the SOC of the battery 100 is lower than a reference low SOC, thereby reducing a risk of travelling of the vehicle EV2 or an operation of the non-travelling high-electric power load 310 of the vehicle EV2 suddenly stopping due to the driver failing to charge the battery 100.

For example, the navigation device 333 may be implemented as a computing device (a processor, a computer-readable storage medium, a communication bus, an input/output device, an input/output interface, and a network communication interface), and may store charging station location information and/or terrain information (e.g., steep ascents for hills, steep descents for regenerative braking, urban terrain for frequent stop-and-go traffic, highway terrain for constant high speeds, off-road terrain for rough and/or uneven surfaces, mud/snow conditions, loose sand, slippery or icy conditions, gravel roads, windy conditions, etc.) that is remotely received in real time from the outside of the vehicle EV2 or that is stored in advance before being installed in the vehicle EV2. For example, the navigation device 333 may remotely receive, based on a global positioning system (GPS), location information and/or terrain information of the vehicle EV2 in real time from the outside of the vehicle EV2.

For example, if the controller 400 transmits a charging station guidance command signal to the navigation device 333, the navigation device 333 may generate (or remotely receive from the outside of the vehicle EV2), based on the charging station location information and the location information of the vehicle EV2, information about a distance of each of a plurality of charging stations from the vehicle EV2, may generate (or remotely receive from the outside of the vehicle EV2) at least one of information about a location of a charging station closest to the vehicle EV2, among the plurality of charging stations, information about a remaining distance to the charging station, and information about terrain to the charging station, and may output (for example, display output, speaker output), toward the driver, at least one of the information about the location of the charging station, the information on the remaining distance to the charging station, and the information about the terrain to the charging station.

The controller 400 may transmit the charging station guidance command signal to the navigation device 333 while controlling (for example, transmitting the command signal to the battery management system 200) non-travelling high-electric power used by the non-travelling high-electric power load 310 to be lowered. The controller 400 may control an output lowering value of the non-travelling high-electric power load 310 to be determined based on at least one of the information about the remaining distance to the charging station and the information about the terrain to the charging station, generated by the navigation device 333. Accordingly, while the vehicle EV2 is travelling to the charging station, the non-travelling high-electric power may be further optimized, and adverse effects caused by output lowering of the non-travelling high-electric power load 310 may be stably prevented.

For example, the output lowering value may increase as the remaining distance to the charging station increases, may increase as a change in height of the terrain to the charging station increases, and may increase as there are more intersections in the terrain to the charging station. For example, the controller 400 may calculate the output lowering value using a predetermined equation multiplying, as variables, the remaining distance, a degree of height change, and the number of intersections to each other, and may transmit, based on the calculated output lowering value, the command signal to the battery management system 200.

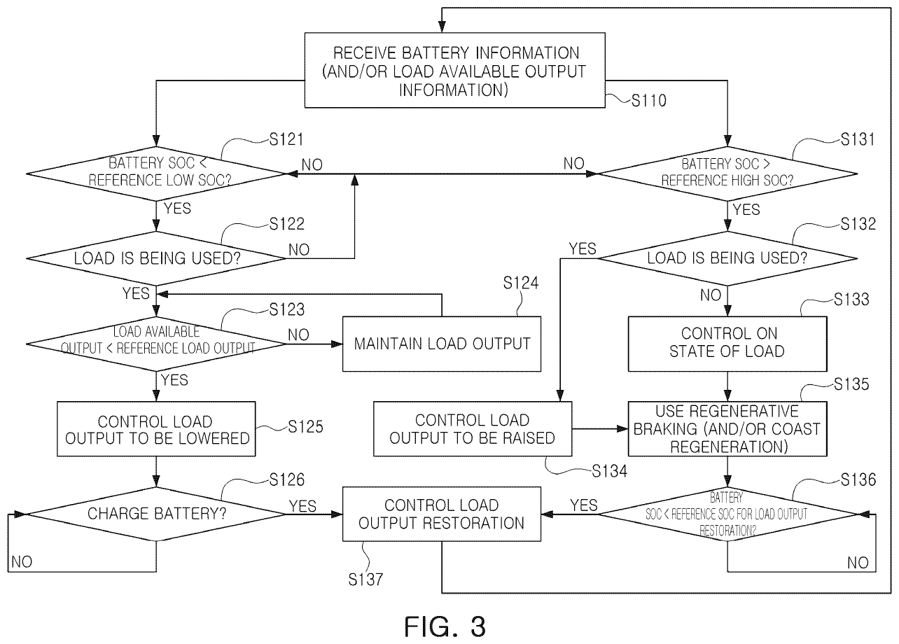

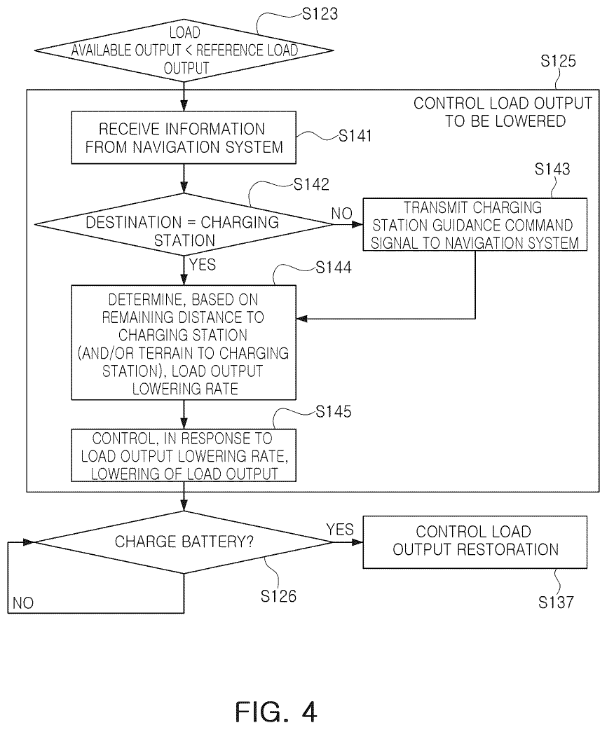

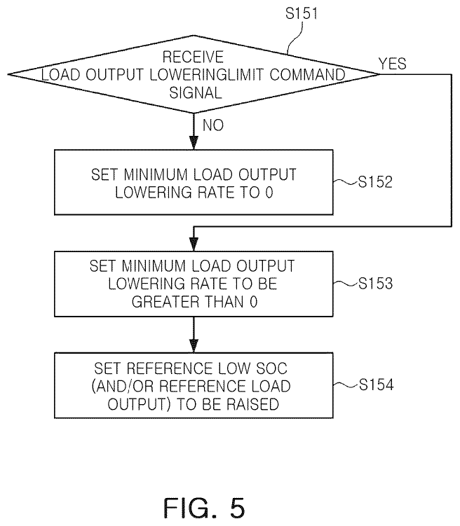

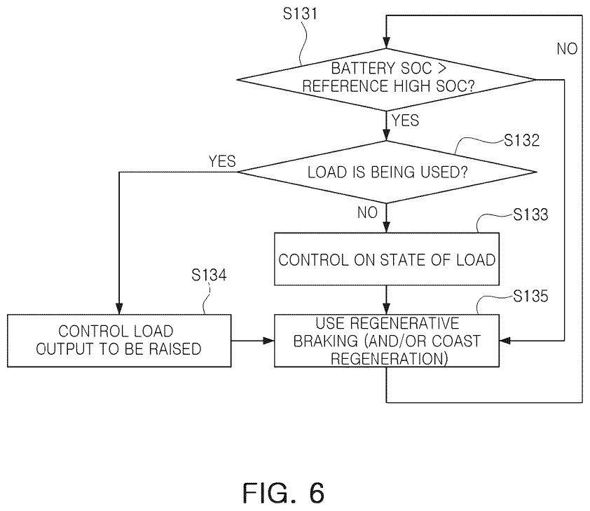

FIG. 3 shows an example of a flowchart showing a control sequence of the controller 400 of the vehicle electric power system according to an example of the present disclosure illustrated in FIG. 1 and/or FIG. 2. Referring to FIGS. 2 and 3, the controller 400 of the vehicle electric power system according to an example of the present disclosure may receive information about the battery 100 (and/or load available output information) (S110), may compare an SOC of the battery 100 and a reference low SOC to each other (S121), may verify whether the non-travelling high-electric power load 310 is being used if the SOC of the battery 100 is lower than the reference low SOC (S122), may compare an available output of the non-travelling high-electric power load 310 and a reference load output to each other if the non-travelling high-electric power load 310 is being used (S123), may maintain an output of the non-travelling high-electric power load 310 if the available output of the non-travelling high-electric power load 310 is higher than or the same as the reference load output (S124), may control the output of the non-travelling high-electric power load 310 to be lowered if the available output of the non-travelling high-electric power load 310 is lower than the reference load output (S125), may monitor charging of the battery 100 (S126), and may control the output of the non-travelling high-electric power load 310 to be restored.

The controller 400 may selectively control, depending on the available output of the non-travelling high-electric power load 310 based on the SOC of the battery 100 is lower than the reference load output, the output of the non-travelling high-electric power load 310 to be lowered if the SOC of the battery 100 is lower than the reference low SOC, and may control the output of the non-travelling high-electric power load 310 to be restored if the battery 100 is charged after the output of the non-travelling high-electric power load 310 is lowered.

For example, assuming that total real-time electric power provided by the battery 100 is maintained, the controller 400 may calculate time used for a current SOC of the battery 100 to reach 0%, and may compare a value obtained by multiplying the calculated time by real-time non-travelling high-electric power to the reference load output. A difference between the SOC of the battery 100 and the available output of the non-travelling high-electric power load 310 may vary depending on a type/model of the non-travelling high-electric power load 310 or a frequency/pattern of use of the non-travelling high-electric power load 310 by a driver. For example, if the non-travelling high-electric power load 310 is a refrigerator, the controller 400 may receive, from the refrigerator, current temperature information and air conditioning blow setting information of the refrigerator, and may calculate, based on the received information, an available output of the refrigerator.

FIG. 4 shows an example of a flowchart showing further reification or replacement of output lowering control (S125) of FIG. 3. Referring to FIGS. 2 and 4, the controller 400 of the vehicle electric power system according to an example of the present disclosure may receive information from a navigation system (for example, the navigation device 333 in FIG. 2) (S141), may verify whether a current destination of the vehicle EV2 is a charging station (S142), may transmit a charging station guidance command signal to the navigation system (for example, the navigation device 333 in FIG. 2) if the destination is not the charging station (S143), may determine, based on a remaining distance to the charging station (and/or terrain to the charging station), a load output lowering rate (S144), and may control, in response to the load output lowering rate, lowering of an output of the non-travelling high-electric power load 310 (S145).

FIG. 5 shows an example of a flowchart showing further reification or replacement of load output lowering rate determination (S144) of FIG. 4. Referring to FIGS. 2 and 5, the controller 400 of the vehicle electric power system according to an example of the present disclosure may monitor whether a load output lowering limit command signal is received from a driver (S151), may set a minimum load output lowering rate to 0 if the load output lowering limit command signal is not received (S152), may not limit load output lowering and set the minimum load output lowering rate to be greater than 0 if the load output lowering limit command signal is received (S153), and may limit load output lowering and set a reference low SOC (and/or a reference load output) to be raised (S154).

The controller 400 may control, in response to reception of the load output lowering limit command signal from the driver, a lower output limit of the non-travelling high-electric power load 310 to be raised, and may control at least one of the reference low SOC and the reference load output to be raised. For example, if the driver replaces items stored in a refrigerator with items requiring higher freshness, the driver may input the load output lowering limit command signal through the non-travelling high-electric power load 310 and/or the non-travelling low-electric power load 330 of the vehicle EV2. For example, if the driver is far from a location in which items, stored in the refrigerator, are to be delivered, the driver may cancel input of the load output lowering limit command signal through the non-travelling high-electric power load 310 and/or the non-travelling low-electric power load 330 of the vehicle EV2.

FIG. 6 shows an example of a flowchart in which part of the control sequence of the controller 400 of the vehicle electric power system according to an example of the present disclosure shown in FIG. 3 is omitted. Referring to FIGS. 2, 3, and 6, the controller 400 of the vehicle electric power system according to an example of the present disclosure may receive information (and/or load available output information) about the battery 100 (S110), may compare an SOC of the battery 100 and a reference high SOC to each other (S131), may verify whether the non-travelling high-electric power load 310 is being used if the SOC of the battery 100 is higher than the reference high SOC (S132), may control switching to an ON state of the non-travelling high-electric power load 310 if the non-travelling high-electric power load 310 is in an unused state (S133), may control output raising of the non-travelling high-electric power load 310 if the non-travelling high-electric power load 310 is being used (S134), may control use of regenerative braking (and/or coast regeneration) of the motor system 320 (S135), may compare the SOC of the battery 100 and a reference SOC for load output restoration to each other (S136), and may control output restoration of the non-travelling high-electric power load 310 if the SOC of the battery 100 is lower than the reference SOC for load output restoration (S137).

The controller 400 may control an output of the non-travelling high-electric power load 310 to be raised if the SOC of the battery 100 is higher than the reference high SOC, and may control the non-travelling high-electric power load 310 to be turned on if the SOC of the battery 100 is higher than the reference high SOC and the non-travelling high-electric power load 310 is turned off.

Referring to FIGS. 1 and 2, the controller 400 of the vehicle electric power system and the refrigerator vehicle including the same according to an example of the present disclosure may include at least one processor 401, a computer-readable storage medium 402, and a communication bus 403. The communication bus 403 may interconnect various other components of the computing device 400, including the processor 401 and the computer-readable storage medium 402.

The processor 401 may cause the computing device 400 to operate according to the examples described above. For example, the processor 401 may execute one or more programs stored in the computer-readable storage medium 402. The one or more programs may include one or more computer-executable instructions. When executed by the processor 401, the one or more computer-executable instructions may be configured to cause the computing device 400 to perform operations according to examples.

The computer-readable storage medium 402 may be configured to store the computer-executable instruction or program code, program data, and/or other suitable forms of information. A program 402a stored in the computer-readable storage medium 402 may include a set of instructions executable by the processor 401. In an example, the computer-readable storage medium 402 may be a memory (volatile memory such as a random access memory, non-volatile memory, or any suitable combination thereof), one or more magnetic disk storage devices, optical disk storage devices, flash memory devices, other types of storage media that are accessible by the computing device 400 and are capable of storing desired information, or any suitable combination thereof.

The computing device 400 may also include one or more input/output interfaces 405 providing an interface for one or more input/output devices 404, and one or more network communication interfaces 406. The input/output interface 405 and the network communication interface 406 may be connected to the communication bus 403. The network may be one of a cellular network, such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), or long-term evolution (LTE), or another cellular network, and may be implemented as Ethernet, media-oriented systems transport (MOST), Flexray, controller area network (CAN), local interconnect network (LIN), Internet, Bluetooth, near field communication (NFC), Zigbee®, radio frequency (RF), or the like.

The input/output device 404 may be connected to other components of the computing device 400 through the input/output interface 405. The exemplary input/output device 404 may include a pointing device (such as a mouse or trackpad), a keyboard, a touch input device (such as a touchpad or touchscreen), a voice or sound input device, input devices such as various types of sensor devices and/or photographing devices, and/or output devices such as a display device, a printer, a speaker, and/or a network card. The exemplary input/output device 404 may be included in the computing device 400 as a component included in the computing device 400, or may be connected to the computing device 400 as a device distinct from the computing device 400.

Energy efficiency and/or operational reliability of electric power-based vehicles further having a non-travelling high-electric power load (for example, a refrigerator) may become more important.

The present disclosure provides a vehicle electric power system capable of improving energy efficiency and/or operational stability of a vehicle using both travelling electric power and non-travelling high-electric power, and a refrigerator vehicle including the same.

According to an example of the present disclosure, there is provided a vehicle electric power system including a motor system configured to use travelling electric power of a vehicle, a non-travelling high-electric power load configured to use non-travelling high-electric power of the vehicle, a non-travelling low-electric power load disposed on the vehicle, the non-travelling low-electric power load configured to use electric power lower than the non-travelling high-electric power load, a battery configured to provide the travelling electric power and the non-travelling high-electric power, and a controller configured to control, in response to a state of charge (SOC) of the battery, lowering or raising of the non-travelling high-electric power.

According to another example of the present disclosure, there is provided a vehicle electric power system including a motor system configured to use travelling electric power of a vehicle, and to generate energy using regenerative braking, a non-travelling high-electric power load configured to use non-travelling high-electric power of the vehicle, a non-travelling low-electric power load disposed on the vehicle, the non-travelling low-electric power load configured to use electric power lower than the non-travelling high-electric power load, a battery configured to provide the travelling electric power and the non-travelling high-electric power, and to store the energy generated using the regenerative braking, and a controller configured to control the energy generated using the regenerative braking to be provided to the non-travelling high-electric power load, if an SOC of the battery is higher than a reference high SOC.

According to another example of the present disclosure, there is provided a vehicle electric power system including a motor system configured to use travelling electric power of a vehicle, a non-travelling high-electric power load configured to use non-travelling high-electric power of the vehicle, a non-travelling low-electric power load including a navigation device, the non-travelling low-electric power load disposed on the vehicle, the non-travelling low-electric power load configured to use electric power lower than the non-travelling high-electric power load, a battery configured to provide the travelling electric power and the non-travelling high-electric power, and a controller configured to control the navigation device to generate charging station guidance information, if an SOC of the battery is lower than a reference low SOC.

According to another example of the present disclosure, there is provided a refrigerator vehicle including the vehicle electric power system. The non-travelling high-electric power load may include a refrigerator.

Example of the present disclosure may include a program for performing the methods described herein on a computer, and a computer-readable recording medium including the program. The computer-readable recording medium may include, alone or in combination with program instructions, local data files, local data structures, and the like. The medium may be those specially designed and constructed for the purposes of the examples, or may be of the well-known kind and available to those having skill in the computer software arts. Examples of the computer-readable medium include magnetic media such as hard disks, floppy disks, and magnetic tape, optical media such as CD ROM discs and DVDs, magneto-optical media such as optical discs, and hardware devices that are specially configured to store and perform program instructions, such as read-only memory (ROM), random access memory (RAM), flash memory, and the like. Examples of the program may include both a machine code, such as a code produced by a compiler, and a higher-level code that may be executed by the computer using an interpreter.

As set forth above, a vehicle electric power system and a refrigerator vehicle including the same according to an example of the present disclosure may improve energy efficiency and/or operational stability of a vehicle using both travelling electric power and non-travelling high-electric power. For example, the vehicle electric power system and the refrigerator vehicle including the same according to an example of the present disclosure may prevent a risk of vehicle travelling or a non-travelling high-electric power load operation suddenly stopping due to a decrease in SOC of the battery, and may reduce a frequency/time of battery charging used by a driver.

While examples have been shown and described above, it will be apparent to those skilled in the art that modifications and variations could be made without departing from the scope of the present disclosure as defined by the appended claims.

What is claimed is:

1. A power system comprising:
a motor system configured to use an electric power, of a vehicle, configured for travelling, wherein the motor system is configured to control, based on the electric power, a movement of the vehicle;
a first electric power load configured to use a first electric power, of the vehicle, configured for non-travelling;
a second electric power load configured to use a second electric power, of the vehicle, configured for non-travelling, wherein the second electric power is lower than the first electric power;
a battery configured to provide the electric power configured for travelling and the first electric power configured for non-travelling; and
a controller configured to adjust, based on a state of charge (SOC) value of the battery, an output value of the first electric power load.

2. The power system of claim 1, wherein the controller is configured to adjust, based on the SOC value of the battery, an output value of the first electric power within a larger range compared to an adjustable range of the electric power.

3. The power system of claim 1, wherein the controller is configured to decrease, based on whether an available output value of the first electric power load being lower than a reference load output value and the SOC value being lower than a reference low SOC value, an output value of the first electric power load.

4. The power system of claim 3, wherein the controller is configured to, based on the battery being charged after the output value of the first electric power load being decreased, restore an output value of the first electric power load.

5. The power system of claim 3, wherein the controller is configured to increase, based on reception of a load output lowering limit command signal, at least one of the reference low SOC value and the reference load output value.

6. The power system of claim 1, wherein the controller is configured to increase, based on reception of a load output lowering limit command signal, a lower output value limit of the first electric power load.

7. The power system of claim 1, wherein
the second electric power load comprises a navigation device disposed on the vehicle, and
the controller is configured to control, based on the SOC value of the battery being lower than a reference low SOC value, the navigation device to generate charging station guidance information.

8. The power system of claim 7, wherein the controller is configured to determine an output value of the first electric power load based on at least one of:
information, generated by the navigation device, about a remaining distance to a charging station, or
information, generated by the navigation device, about terrain to the charging station.

9. The power system of claim 1, wherein the controller is configured to increase, based on the SOC value of the battery being higher than a reference high SOC value, an output value of the first electric power load.

10. The power system of claim 9, wherein the controller is configured to turn on, based on the SOC value of the battery being higher than the reference high SOC value and the first electric power load being turned off, the first electric power load.

11. The power system of claim 9, wherein
the motor system is configured to generate, based on regenerative braking, energy,
the battery is configured to store the energy, and
the controller is configured to control, based on the SOC value of the battery being higher than the reference high SOC value, the energy to bypass the battery and provide the energy to the first electric power load.

12. The power system of claim 1, wherein the first electric power load comprises a refrigerator.

13. A power system comprising:
a motor system configured to use an electric power, of a vehicle, configured for travelling, and to generate, based on regenerative braking, energy, wherein the motor system is configured to control, based on the electric power, a movement of the vehicle;
a first electric power load configured to use a first electric power, of the vehicle, configured for non-travelling;
a second electric power load configured to use a second electric power, of the vehicle, configured for non-travelling, wherein the second electric power is lower than the first electric power;
a battery configured to provide the electric power configured for travelling and the first electric power configured for non-travelling, and to store the energy generated based on the regenerative braking; and
a controller configured to provide, based on a state of charge (SOC) value of the battery being higher than a reference high SOC value, the energy to the first electric power load.

14. The power system of claim 13, wherein the first electric power load is configured to receive, based on the SOC value of the battery being higher than the reference high SOC value and from the motor system, the energy generated based on the regenerative braking.

15. The power system of claim 13, wherein the motor system is configured to use the regenerative braking in a braking situation of the vehicle.

16. The power system of claim 13, wherein
the second electric power load comprises a navigation device disposed on the vehicle, and
the controller is configured to control, based on the SOC value of the battery being lower than a reference low SOC value, the navigation device to generate charging station guidance information.

17. The power system of claim 13, wherein the first electric power load comprises a refrigerator.

18. A power system comprising:
a motor system configured to use an electric power, of a vehicle, configured for travelling, wherein the motor system is configured to control, based on the electric power, a movement of the vehicle;
a first electric power load configured to use a first electric power, of the vehicle, configured for non-travelling;
a second electric power load configured to use a second electric power of the vehicle, wherein the second electric power is lower than the first electric power, wherein the second electric power load comprises a navigation device disposed on the vehicle;
a battery configured to provide the electric power configured for travelling and the first electric power configured for non-travelling; and
a controller configured to control, based on a state of charge (SOC) value of the battery being lower than a reference low SOC value, the navigation device to generate charging station guidance information.

19. The power system of claim 18, wherein
the controller is configured to:
decrease an output value of the first electric power load, and
determine an output value of the first electric power load based on at least one of:
information, generated by the navigation device, about a remaining distance to a charging station, or
information, generated by the navigation device, about terrain to the charging station.

20. The power system of claim 18, wherein the first electric power load comprises a refrigerator.
